(19) United States
(12) Patent Application Publication
(10) Pub. No.: US 2004/0081348 A1
(43) Pub. Date: Apr. 29, 2004

(54) Apparatus and a method for controlling textile articles such as, for example, socks

(76) Inventor: Gino Bassi, Bologna (IT)

Correspondence Address: MCGLEW & TUTTLE, PC, 1 SCARBOROUGH STATION PLAZA, SCARBOROUGH, NY, 10510-0827, US

(21) Appl. No.: 10/684,543

(22) Filed: Oct. 14, 2003

(30) Foreign Application Priority Data
Jul. 11, 2002 (IT) FI2002A000218

(51) Int. Cl. G06K 9/00

(52) U.S. Cl. 382/141; 356/238.1

(57) ABSTRACT

The invention relates to an apparatus and a method for controlling textile articles such as, for example, socks; the apparatus is utilizable in correspondence of an ironing station in which, between a station for loading the articles on relevant support shapes and a station for unloading the same articles therefrom, the articles are subjected to the action of ironing means; the apparatus comprises: at least a telecamera (9; 9′) provided with an optical group (90) located at a preset position in order to frame an article (4) fitted on a shape (3) and disposed in stretched condition thereon; electronic checking means (92) able to detect a signal, emitted by said optical group (90), exceeding a predetermined threshold value and corresponding to a non-uniformity of reflection of light from said article (4) and/or said shape (3); means (94), electrically associated with said checking means, which are disposed and acting within an article-unloading device (20) for conveying the articles towards either a region (21) for unloading the articles which are of acceptable quality or a region (22) for discharging faulty articles, according to the result of said checking, that is, according to the nature (A, N) of a corresponding electrical signal generated by said means (92) upon said checking (FIG. 1A).

The present invention relates to an apparatus and a method for controlling textile articles such as, for example, socks.

### BACKGROUND OF THE INVENTION

The process for producing socks is known to include, after the knitting and toe-closing step, an ironing step and a final packaging step.

For the ironing, the socks are fitted, manually or with the aid of machines, onto flat shapes where the same socks are acted upon by ironing means. Generally, the sock-supporting shapes follow an operating path extending between a loading station connected to upstream-disposed textile machines, and a final unloading station connected to downstream-disposed packaging stations.

### SUMMARY OF INVENTION

The main object of the present invention is to automatically and accurately detect the flaws of textile articles such as, socks, for example. This result has been achieved, according to the invention, by providing an apparatus and a method having the characteristics indicated in the independent claims. Further characteristics being set forth in the dependent claims.

The advantages deriving from the present invention lie essentially in the fact that it is possible to detect flaws, if any, in the article, prior to the packaging step; that it is possible to detect the imperfections with extreme accuracy; that it is possible to memorize the various types of imperfections so as to carry out case records about the quality of the product; that an apparatus according to the invention is relatively simple to make and to use, and it is able to maintain its characteristics unchanged even after a prolonged service life; that the implementation of the invention implies relatively moderate maintenance costs.

### BRIEF DESCRIPTION OF THE DRAWINGS

These and other advantages and characteristics of the invention will be best understood by anyone skilled in the art from a reading of the following description in conjunction with the attached drawings given as a practical exemplification of the invention, but not to be considered in a limitative sense, wherein:

FIG. 1A is a possible embodiment of an apparatus according to the invention, shown schematically in perspective top view;

FIG. 1B is a further embodiment of the apparatus shown as in the preceding figure in a perspective top view;

FIG. 1C shows a detail relating to a shot taken with a telecamera making part of the embodiments of the preceding figures and wherein the framing of the telecamera is shown schematically with dotted line;

FIG. 2 is a block diagram of an apparatus according to the invention.

### DETAILED DESCRIPTION OF THE INVENTION

With reference to the figures of the attached drawings, an apparatus according to the invention is to be used in correspondence of an ironing station 1.

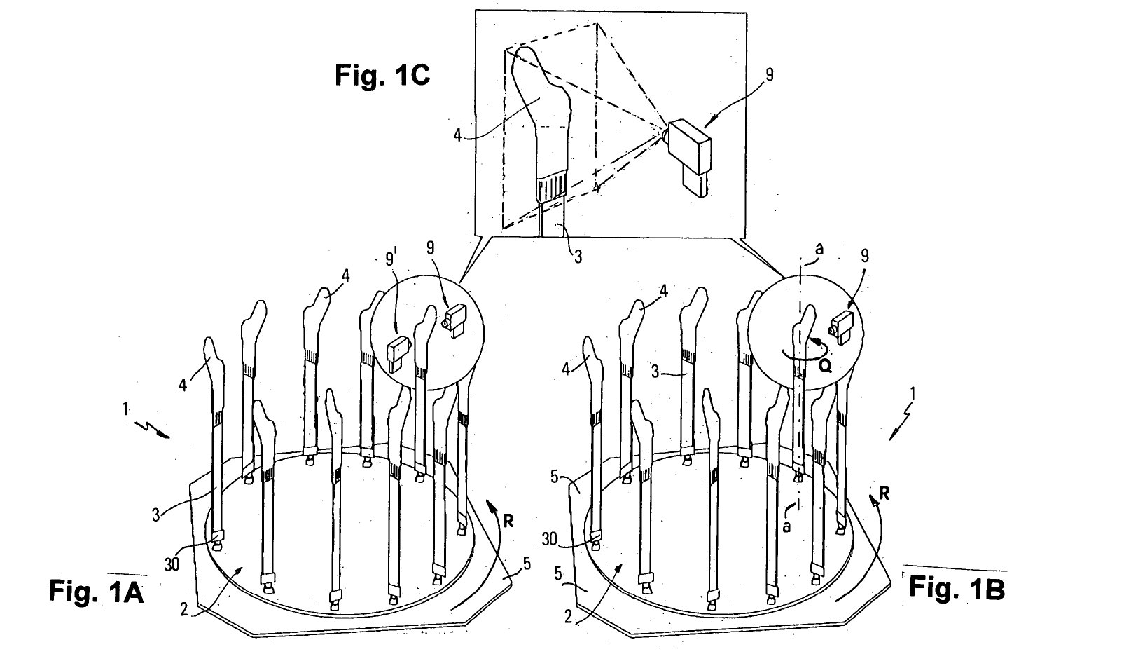

Provided in the ironing station 1 is a plurality of shapes 3 vertically disposed on a horizontal platform 2 which is driven into rotation relative to a base 5 of the ironing station 1. A possible direction of rotation is counterclockwise, as indicated by R in FIGS. 1A and 1B. The motion of platform 2 relative to the base 5 can be carried out, for example, by means of a toothed chain (not shown) suitably motor-driven or operated by other driving means.

It will be appreciated that the shapes 3 may be disposed also otherwise, for example horizontally, without departing from the scope of the invention.

The shapes 3 are connected to the rotary platform 2 via relevant supports 30 which, especially in the embodiment shown in FIG. 1B, allow the rotation of the shapes 3 about their own longitudinal, vertically disposed axes a-a. The rotation of shapes 3, on which relevant socks 4 are loaded, can be obtained, for example, by means of a pneumatic actuator so as to rotate the shapes by an angle of 180°. Advantageously, use can be made of the actuator currently present in the ironing stations of the known machines, and which performs rotations through 90° in correspondence of the loading of socks onto the shapes and of the unloading thereof from the same shapes.

Attached on a fixed part of the ironing station 1 is at least one telecamera 9, so positioned as to be able to frame the whole article 4 fitted onto the relevant, shape 3; in practice, the telecamera 9 is located at a, site from which it is possible to frame the sock 4 when the latter is put in stretched condition on the shape 3. Preferably, the telecamera 9 is disposed downstream of the ironing means to frame the sock 4 when the latter has been already ironed.

The filming of the telecamera 9 is activated the moment the shape 3 reaches a determined position during its travel along the ironing station.

The shape 3 is made of a material which, when subjected to a luminous radiation, reflects the latter differently from the fabric of sock 4. For example, the shapes may be made from a metal, especially from polished aluminum, so as to reflect the light in a way considerably different from that of the fabric of the sock fitted on the same shape. The difference of reflection detected by the telecamera allows, therefore, the identification of possible defects present on the socks.

In the example of FIG. 1A, there are provided two telecameras 9 and 9′ able to frame both sides of shape 3; in the example of FIG. 1B, the framing of both sides of the shape is obtained by rotating the shape (arrow Q) as above described. It is thus possible to have two operating modes: in the case shown in FIG. 1A, the total time for the image acquisition will be shorter, as each camera is to take one side of the shape only, in the case of FIG. 1B instead, the image acquisition will take a longer time, but the construction of the apparatus will be simpler.

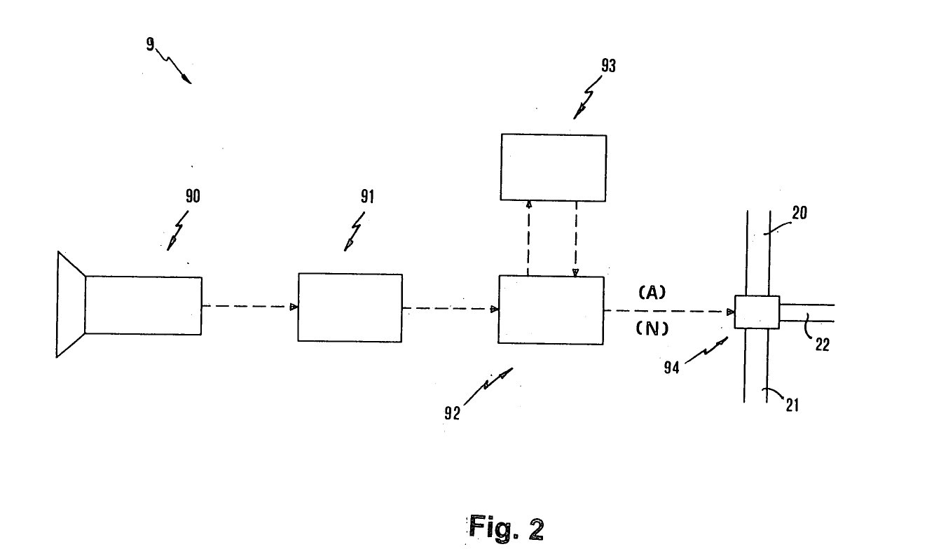

With reference to FIG. 2, the telecamera 9 includes an optical group 90, an A/D converter 91, and programmable electronic means 92 to process the signals from the converter 91. The type of telecamera to be used may be, for example, OMRON F 150/160 provided with programmable CPU.

The images taken by the optical group 90—which is positioned so as to frame the whole article on the shape 3—correspond, as well known, to analog electrical signal which will result of digital format on its output from the converter 91. The digital image corresponds to an array of pixels characterized by a substantially uniform color or luminosity within the area of the shape 3 covered by the sock. On the contrary, the image relevant to the portion of shape 3 uncovered by the sock 4 will give an array of pixels of different nature owing to the different reflection's characteristics of the light.

The image of an unsound, that is, pierced or unstitched sock 4 will include a portion of pixels being characterized by a color or luminosity other than that of the remaining area covered by the sock 4.

Similarly, in case of the presence of one or more threads unproperly tied and/or cut, the latter would move downwards by gravity thereby covering the portion of shape 3 normally uncovered by the sock 4. In this case, too, there would be a difference of reflection detectable by the present apparatus.

In a possible mode of operation, it is sufficient that the CPU 92 of the telecamera be calibrated for threshold values relating to the presence of reflection inside the area of the stock, and/or relating to the absence of reflection inside the area of the uncovered portion of the shape, in order to take into account the above described situations. In practice, in case the above said threshold values are met (good product), the CPU generates a signal A of acknowledgment of the article, that is, a signal that enables the article to be unloaded through a station 22 for the unloading of articles which have an acceptable quality; on the contrary, for articles recognized as unsuited, the CPU 92 generates a signal N of rejection of the article which, consequently, will be discharged through a station 21 for the discharge of products whose quality is unacceptable.

In addition, or as an alternative to the above described mode of operation, the CPU 92 of telecamera 9 includes a memory section 93 storing a plurality of images which are acquired upon a preliminary step of presetting the apparatus, and correspond to sound as well as defective socks. Once the telecamera 9 acquires the real image of one sock, this image is compared with those stored by reference in the section 93 of CPU 92. The comparison is made by the same CPU 92. If the pixels corresponding to the acquired image (real image) are of a color or luminosity corresponding to that preset as acceptable for the covered area of the sock 4 and/or for the uncovered area of the shape 3, that is, the digitized real area overlaps the stored image of an integral and well sewn sock or article, then the CPU 92 generates a signal A of acceptance of the article, that is, a signal enabling the article to be unloaded through a station intended for unloading articles of acceptable quality. If, on the contrary, the pixels of the real image are not all of the color (or luminosity) corresponding to that being preset for the said covered and uncovered areas, so that the digitized real image does not overlap the reference image stored in memory, then the CPU 92 generates a signal N of non acceptance of the article which, as a consequence, will be discharged through a section 21 for the discharge of products having unacceptable quality.

The generation of said signal N of non-acceptance can be preceded by a sequential comparison of the real image with the images of faulty products stored in memory, in order to establish the nature of the defect and set up a case record of the events, which can be useful in detecting a major or minor recurrence of some defects with respect to others, and for providing proper measures for ascertaining and eliminating the sources of such defects.

In particular, the said signal N/A, on output from the CPU 92, is intended to drive a solenoid valve 94 which intercepts an unloading device, such as a pneumatic circuit 20, for the exit of articles, to cause the unloading thereof through either the section 21 for the output of products having acceptable quality, or the section 22 for the output of faulty products, depending on the “A” or “B”-type of signal generated by the CPU 92.

The above said checking operations can be carried out, all or in part, in the indicated or different order, depending on how the CPU 92 is programmed. In any case, the speed by which the checks are made, will be proportional to the CPU's computation speed, but in any case higher than that of a human operator.

As far as the operation is concerned, a sock 4 is initially loaded onto a shape 3 in a manual or automated way. Thereafter, the shape 3 with the sock fitted thereon is made to reach means able to perform the ironing, the action of these means being: capable of giving the sock 4 its final configuration upon exiting from the ironing station wherein, as described above, the same sock is stretched and ironed. At this point a check is made by the telecamera 9. Alternatively, the checking by the telecamera 9 can be made upstream of the ironing station, that is, by framing the article fitted on the shape but still to be ironed.

The checking step, intended as above said to detect any possible flaw, is carried out by framing an article 4, fitted on the shape 3 in stretched condition (and possibly ironed), by means of the optical group 90 of the telecamera 9, the latter being located at a preset site, preferably, but not exclusively, downstream of the ironing means.

A check is made whether the color or luminosity of the acquired image corresponds or not to a preset threshold value related to the capacity of said article 4 and/or said shape 3 of reflecting the light. According to the check result, that is, to the nature (signals A, N above mentioned) of a corresponding electrical signal generated by the checking means, the articles are conveyed either to the region 21 for the unloading of those having acceptable quality or to the region 22 for the discharge of the faulty ones.

According to the present invention, moreover, it is possible to convert each image taken by the telecamera's optical group 90 into a digital format and to form a digital image corresponding to an array of pixels of a substantially uniform color or luminosity, in relation to the conformation or structure of the article 4 and/or the material of the shape 3.

Then, a check is made whether the color or luminosity of said images will correspond to the color and luminosity of the pixels of one or more digital sample images stored in the electronic memory 93, and corresponding to the images either of sound and well conformed articles or of faulty ones. At this point, likewise the preceding example, according to the outcome of the check carried out also by the memory 93, the articles are conveyed either to the region 21 for the unloading of those having acceptable quality or to the region 22 for the discharge of the faulty ones.

The construction details may vary in any equivalent way as far as the shape, dimensions, elements disposition, nature of the used materials are concerned, without nevertheless departing from the scope of the adopted solution idea and, thereby, remaining within the limits of the protection granted to the present patent.

What is claimed is:

1. An apparatus for detecting the presence of flaws in textile articles, especially socks, utilizable in correspondence of an ironing station in which, between a station for loading the articles on relevant support shapes and a station for unloading the same articles therefrom, the articles are subjected to the action of ironing means, apparatus that comprises:
at least a telecamera (9; 9′) provided with an optical group (90) located at a preset position in order to frame an article (4) fitted on a shape (3) and disposed in stretched condition thereon;
electronic checking means (92) able to detect a signal, emitted by said optical group (90), exceeding a predetermined threshold value and corresponding to a non-uniformity of reflection of light from said article (4) and/or of said shape (3);
means (94), electrically associated with said checking means, which are disposed and acting within an article-unloading device (20) for conveying the articles towards either a region (21) for unloading the articles which are of acceptable quality or a region (22) for discharging faulty articles, according to the result of said checking, that is, according to the nature (A, N) of a corresponding electrical signal generated by said means (92) as a consequence of said checking.

2. The apparatus of claim 1, wherein it comprises:
electronic means (91) to convert each image taken by said optical group (90) into a digital format and to form a corresponding digital image which corresponds to an array of pixels of substantially uniform color or luminosity related to the conformation or structure of the article's fabric or the shape supporting it;
electronic means (92) in order to check whether the color or luminosity and/or relative position of the pixels of said image will correspond or not to the color or luminosity and/or relative position of the pixels of one or more digital sample images stored in the electronic memory (93) and corresponding to the images either of sound and well conformed articles, or of faulty ones;
means (94), electrically associated with said checking means, which means, are disposed and acting within an article-unloading device (20) in order to convey the articles either to the region (21) for the unloading of those having acceptable quality or to the region 22 for the discharge of the faulty ones, in relation to the outcome of said check, that is, to the nature (A, N) of a corresponding electrical signal generated by said means (92, 93) as a consequence: of their checking action.

3. The apparatus of claim 1 or 2, wherein said apparatus (9; 9′) is disposed downstream of said ironing means.

4. The apparatus of claim 1 or 2, wherein it comprises two telecameras (9, 9′) disposed facing each other, that is, in such a way as to be able to frame two sides of said shapes (3) at the same time.

5. A method for detecting the presence, of flaws in textile articles, especially socks, utilizable in correspondence of an ironing station in which, between a station for loading the articles on relevant support shapes and a station for unloading the same articles therefrom, the articles are,subjected to the action of ironing means, method that comprises the following operating steps:
framing an article (4), fitted onto a shape (3), by means of an optical, group (90) of a telecamera (9) located at a predetermined site;
checking whether the color or luminosity of the acquired image will correspond or not to a preset threshold value related to the capacity of said article (4) and/or said shape (3) of reflecting the light;
conveying the articles towards either a region (21) for unloading the articles which are of acceptable quality, or a region (22) for discharging faulty articles, according to the result of said checking, that is, according to the nature (A, N) of a corresponding electrical signal generated by said means (92) upon said checking.

6. The method of claim 5, wherein it comprises the following operating steps:
conveying each image taken by the telecamera's optical group (90) into a digital format and forming a digital image corresponding to an array of pixels of a substantially uniform color or luminosity in relation to the conformation or structure of the article (4) and/or the material of the shape (3);
checking whether the color or luminosity of said images will correspond to the color and luminosity of the pixels of one or more digital sample images stored in the electronic memory (93) and corresponding to the images either of sound and well conformed articles or of faulty ones;
conveying the articles either to the region (21) for the unloading of those having acceptable quality or to the region (22) for the discharge of the faulty ones, in relation to the outcome of said check, that is to the nature (A, N) of a corresponding electrical signal generated by said means (92, 93) as a consequence of their checking action.

7. The method of claims 5 or 6, wherein said telecamera (9) is located downstream of the ironing means so as to frame the article (4) as it is fitted and stretched on the corresponding shape (3).

8. The method of claims 5 or 6, wherein are used two telecamerae for said framing step.
